(19) United States
(12) Patent Application Publication
(10) Pub. No.: US 2010/0282217 A1
(43) Pub. Date: Nov. 11, 2010

(54) VCR UNIVERSAL DRIVE

(75) Inventor: Karsten Wittek, Aachen (DE)

Correspondence Address: GIFFORD, KRASS, SPRINKLE,ANDERSON & CITKOWSKI, P.C, PO BOX 7021, TROY, MI, 48007-7021, US

(73) Assignee: FEV Motorentechnik GMBH, Aachen (DE)

(21) Appl. No.: 12/811,232

(22) PCT Filed: Dec. 30, 2008
(86) PCT No.: PCT/EP2008/011136

§ 371 Date: Jun. 30, 2010

(30) Foreign Application Priority Data
Dec. 31, 2007 (DE) 10 2008 003 109.7

(51) Int. Cl. F02B 75/04; F16D 3/00

(52) U.S. Cl. 123/48 R; 464/106

(57) ABSTRACT

An internal combustion engine with a variable compression ratio is provided. The engine can have a crankshaft that is pivotably supported, a flywheel fixed on the crankshaft, and a connection shaft that is arranged between the crankshaft and an input shaft of a shift transmission.

### CROSS-REFERENCE TO RELATED APPLICATION

This application is the U.S. National Phase of PCT/EP2008/011136 filed Dec. 30, 2008, which claims priority of German Patent Application 10 2008 003 109/7 filed Dec. 31, 2007, both of which are incorporated herein in their entirety by reference.

### FIELD OF THE INVENTION

The present invention relates to an internal combustion engine and a drivetrain, preferably both for a motor vehicle, in particular, a road vehicle. The internal combustion engine is preferably a multicylinder internal combustion engine, in particular a 3-, 4-, 5- or 6-cylinder engine.

The objective of the invention is to compensate for the axial offset of the crankshaft to the transmission input shaft for VCR engines with eccentric support of the crankshaft.

### BACKGROUND OF THE INVENTION

In the prior art for eccentric crankshaft displacement, either parallel crank transmissions or a spur gear/ring gear transmission stage have been proposed as possibilities for compensation.

It is disadvantageous that slipping and rolling motions occur in both variants, which leads to extra friction. Furthermore, the compensation transmission is located between the crankshaft and the flywheel, which is constituted in part by the compensation transmission itself. Because of the high dynamic torques at the crankshaft flange, which are fundamentally characteristic of internal combustion engines, the compensation transmission is highly stressed and must be correspondingly strongly dimensioned.

In addition, a proposal originates from GB 173,252 to provide an internal combustion engine with a hydraulic device by means of which a crankshaft can be raised and lowered in order to thus vary a compression volume available in an internal combustion engine. One can infer in general from this the provision that a flexible drive must be used to transfer the drive force from the crankshaft to an output shaft that is connected to a transmission. The engine block and the transmission should be fixedly arranged on the vehicle frame. Nothing more can be deduced from this document. A constructive implementation of the crankshaft distribution proposed there is complicated and requires a large expense.

The problem of the present invention is to avoid the above-mentioned disadvantages in the implementation of the above objective.

### SUMMARY OF THE INVENTION

The above stated problem is solved with an internal combustion engine having the characteristics of claim 1 and with a drivetrain having the characteristics of claim 12. Further advantages can be deduced from the subordinate claims, as well as from the description below. Individual characteristics of the individual configurations can be combined with other characteristics from other configurations for refinements of the invention.

The following is proposed, wherein the reference numbers relate to the figures below, without these characteristics being considered to be limiting.

Internal combustion engine with variable compression ratio, with:

a crankshaft (1) that is pivotably supported (2);

a flywheel (3) fixed on the crankshaft (1);

a connection shaft (10, 26, 27, 28) that is arranged between the crankshaft (1) and an input shaft (23) of a shift transmission.

Further proposals provide the following:

Internal combustion engine, wherein the connection shaft has at least one articulated shaft (10, 26, 27, 28) and/or a flexible shaft. A flexible shaft is preferably used for a transaxle drive, in which the internal combustion engine is installed at the front and the transmission is installed at the back, just in front of the drive axle.

According to a refinement, it is preferred that the articulated shaft is at least partially greased. Preferably, a joint between the articulated shaft and the crankshaft and/or the transmission input shaft is greased. For this purpose, a respective enclosure of the [sic]

Internal combustion engine, wherein the articulated shaft has a first stub shaft (10), which is connected to the crankshaft (1), and a second stub shaft (26), which can be connected to the transmission input shaft (23).

Internal combustion engine, wherein the flywheel (3) is arranged between the crankshaft (1) and the connection shaft (10, 26, 27, 28), preferably the first shaft stub (10).

Internal combustion engine, wherein the articulated shaft (10, 26, 27, 28) has at least two joints (10, 28; 26, 28).

Internal combustion engine, wherein an intermediate shaft (27) is arranged between each two neighboring joints (10, 28; 26, 28).

Internal combustion engine, wherein the crankshaft (1) and/or the connection shaft (10, 26, 27, 28) has at least one ball plunging joint.

Internal combustion engine, wherein the joints comprise at least one universal joint (28) and/or at least one constant-velocity joint and/or at least one ball joint and/or at least one tripod joint and/or at least one curved-tooth gear coupling.

Internal combustion engine, wherein the crankshaft (1) is aligned in a defined pivot position with the transmission input shaft (23).

Internal combustion engine, wherein the defined pivot position corresponds to a predeterminable compression ratio that is most commonly used in the operation of the internal combustion engine. For this purpose there can be a statistical evaluation of the driving behavior of the respective user of the vehicle.

Internal combustion engine, wherein the defined pivot position corresponds to the maximum compression ratio.

Drivetrain for a motor vehicle with:

an internal combustion engine (1) according to one of the preceding proposals;

a shift transmission having an input transmission shaft (23);

wherein:

the connection shaft (10, 26, 27, 28) is arranged between the crankshaft (1) and the input transmission shaft (23).

Drivetrain, wherein the input transmission shaft (23) is supported by an additional bearing.

Another configuration provides that, for example, there is an alignment between the crankshaft and the input transmission shaft when the compression ratio epsilon is maximum, particularly preferably an alignment whenever the compression ratio lies in a range of 70-100% of epsilon max.

With the embodiments proposed above, for example, it is possible to avoid extra friction in the engine operating points relevant to fuel consumption, while only slight additional friction results at the other points. This is possible with a small construction effort and low production and assembly costs.

One configuration provides the following: the flywheel remains fixedly bolted to the crankshaft and thereby co-rotates. An articulated shaft is inserted between the crankshaft and the input transmission shaft.

If it is provided that the flywheel and the crankshaft are fixedly bolted together, the articulated shaft is preferably stressed only on the same order of magnitude as the shift transmission.

It is particularly advantageous if the engine and transmission are aligned with one another in such a manner that the crankshaft and the input transmission shaft are aligned whenever an eccentric position is adjusted that preferably corresponds to a compression setting that occurs particularly frequently when driving. This can be done, for example, by evaluating test cycles, as well as by an evaluation of the driving behavior of the vehicle user in the normal operation of a vehicle. Thus the user can be selectively recognized and a corresponding evaluation of the driving mode can be performed. For instance, it is known from engine tests that in the New European Driving Cycle (NEDC) it is possible to drive almost the entire time with maximum compression. If the crankshaft and the transmission shafts are aligned, then the articulated shaft rotates rigidly and there are no sliding or rolling movements, i.e., there is complete friction neutrality.

If a flexible shaft is used, it is easy to flex but torsionally rigid. The flexible shaft is constructed substantially rotationally rigid with respect to torques about the longitudinal axis of the shaft, but is deformable by a force in the direction of the resulting centrifugal force. The flexible shaft thus allows a freer deflection in the rotation of the shaft. In addition, the shaft is preferably symmetrically supported and also deforms symmetrically with respect to the bearing points during rotation, so that tilting of the bearings can be avoided As a result, a bending line of the shaft can be specifically influenced by providing the flexible shaft. To avoid tilting of the bearings, the bearing surfaces can be provided with a convexity. A flexible shaft is preferably used for a transaxle drive.

### BRIEF DESCRIPTION OF THE DRAWINGS

Additional configurations and refinements will be explained in detail with reference to the following drawings. The characteristics described or depicted there are not limited to the respective configuration, however. Rather, one or more characteristics from different configurations, and also from the above description, can be combined within the scope of the invention into additional configurations. Moreover, the characteristics following from the drawings should not be interpreted as being limiting, but only explanatory. The invention will be explained in detail below with reference to the drawings:

FIG. 1 shows a longitudinal section through an engine-transmission combination; the last crankshaft cam is shown, but only the end of a crankshaft;

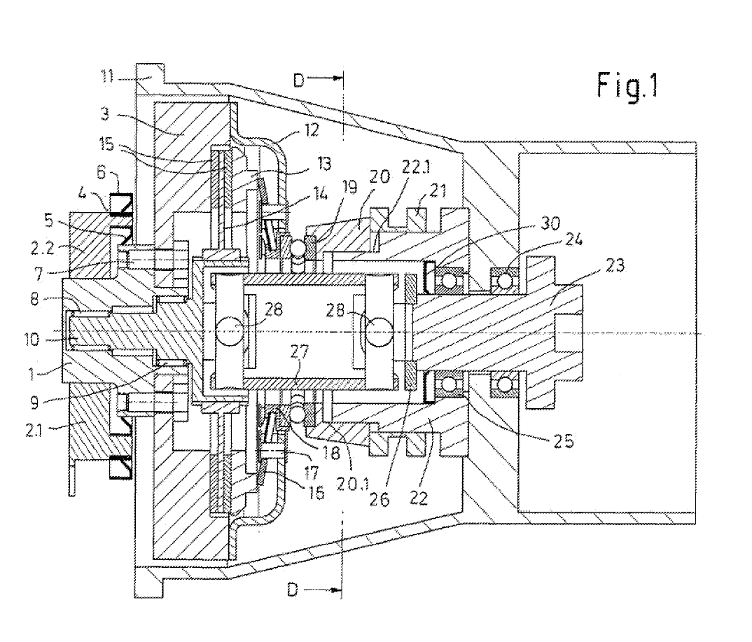

FIG. 2 shows the end of the crankshaft, the articulated shaft and the input transmission shaft;

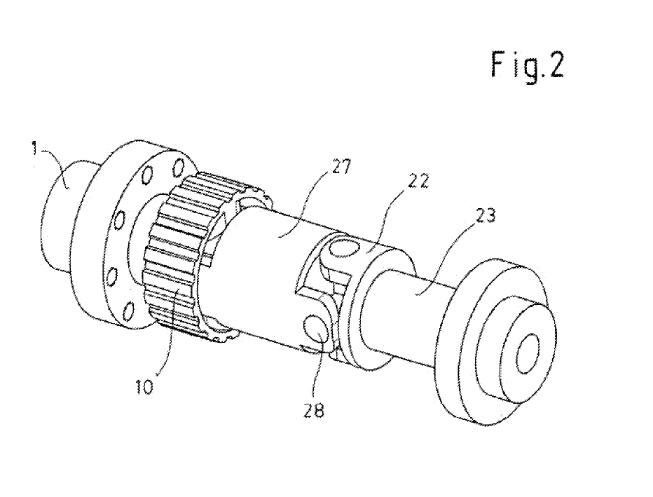

FIG. 3 is a front view of a transmission, with the last cam;

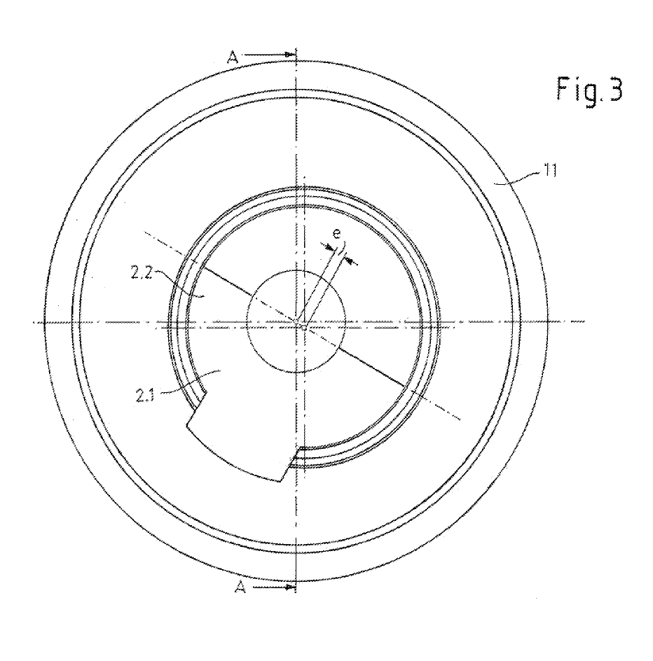

FIG. 4 shows a release mechanism;

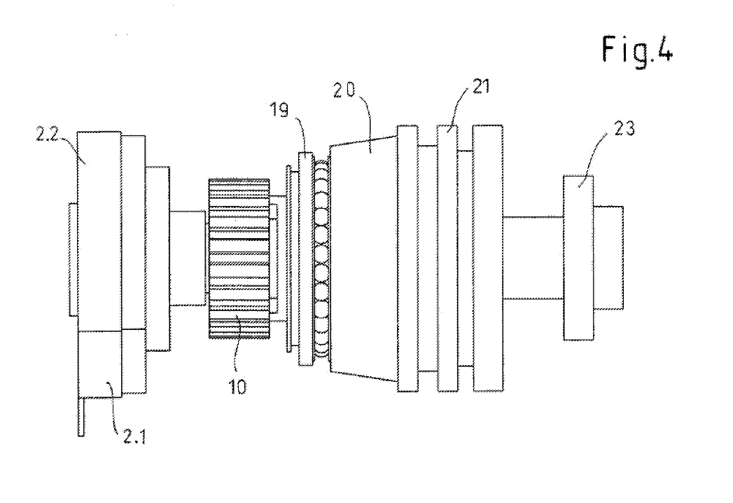

FIG. 5 shows a longitudinal section through an engine without the transmission; and

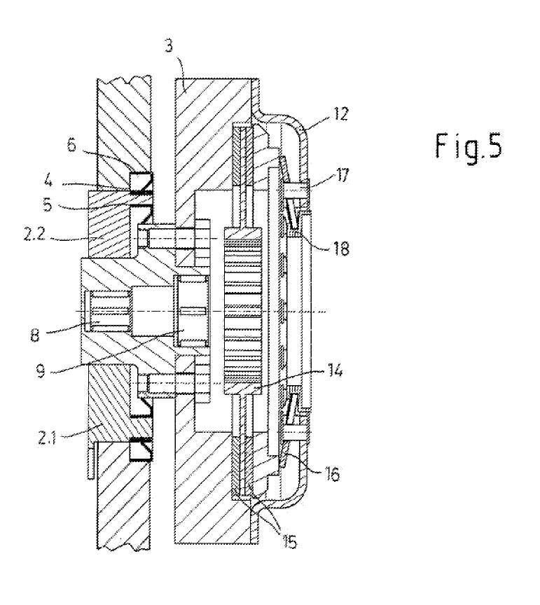

FIG. 6 shows the cross-section through a release bearing mechanism.

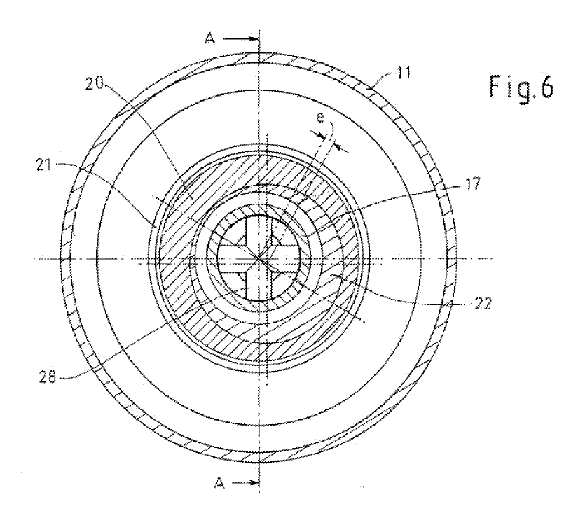

### DETAILED DESCRIPTION OF THE INVENTION

A configuration, which is exemplary but not limiting, will be presented in detail with reference to the figures.

The flywheel 3 and the crankshaft 1 are nonpositively connected by means of bolts 7. The crankshaft is supported according to this configuration in cams 2, which usually have a divided design. Undivided cams can also be used, however. The articulated shaft connection can be represented by different machine elements:

cardan joints

constant velocity joints (homokinetic joints)

tripod joints

curved-tooth gear couplings

Since the shafts to be connected are axially parallel, the articulated shaft consists of two joints. Another configuration provides that three or four joints are used, particularly in case axial parallelism is absent.

The front joint 10 is supported by means of the two bearings 8 and 9 statically in the crankshaft. The rear joint 26 is supported by means of the two bearings 24 and 25 statically at the transmission. It is advantageous to seat the input transmission shaft 23 and to connect the rear joint to the transmission input shaft. One configuration provides that, in case of a change of length by the articulated shaft when running in a bent position, a compensation is made possible in that at least one of the two joints can be displaced axially, both joints can be displaced axially and/or length compensation is provided in the intermediate shaft 27.

The driver disk 14 is movable and rotationally fixed to the front joint, e.g., by means of a spline joint. The structure of the starting clutch can correspond to a design that comprises, for example, the following components and their exemplary linking as shown: clutch support 12, pressure plate 13 and diaphragm spring 16. The characteristic here is that the diaphragm spring is pivoted together with the crankshaft on the orbital path. In the proposed configuration, the release bearing 19 is connected to a release body 20, wherein the release body has an eccentric inner surface 20.1 for accommodating the release bearing. The release support 22 has an eccentric outer surface 22.1. The eccentricity of the crankshaft cam must coincide with the eccentricity of the release bearing guide. The release body 20 must be able to rotate freely on the release bearing support. This can be achieved by a bearing such as an additional rolling-contact bearing or by an appropriate material pairing of body surfaces sliding on one another.

The rotation of the release body is transmitted by the diaphragm spring via the release bearing on to the release body. The sliding sleeve 21, on the other hand, is supported concentrically on the release bearing carrier so that, for example, a release fork can be designed conventionally.

The rear cam is seated with respect to the block by an additional retaining ring 6. In order to prevent a lip of the retaining ring from running across the joint of the divided cam, a continuous ring 4 can be shrunk-fit after the joining of the halves of the cam, which assures a secure seal.

The invention is not restricted to the illustrative examples described above. The examples and/or embodiments are not intended as limitations on the scope of the invention. Methods, processes, apparatus, compositions, and the like described herein are exemplary and not intended as limitations on the scope of the invention. Changes therein and other uses will occur to those skilled in the art. The scope of the invention is defined by the scope of the claims.

I claim:

1. An internal combustion engine with variable compression ratio comprising:
a crankshaft (1) that is pivotably supported (2);
a flywheel (3) fixed on the crankshaft (1); and
a connection shaft (10, 26, 27, 28) that is arranged between the crankshaft (1) and an input shaft (23) of a shift transmission.

2. The internal combustion engine according to claim 1, wherein the connection shaft has at least one of an articulated shaft (10, 26, 27, 28) and a flexible shaft.

3. The internal combustion engine according to claim 2, wherein the articulated shaft has a first stub shaft (10), which is connected to the crankshaft (1), and a second stub shaft (26), which is connected to the transmission input shaft (23).

4. The internal combustion engine according to claim 3, wherein the flywheel (3) is arranged between the crankshaft (1) and the connection shaft (10, 26, 27, 28).

5. The internal combustion engine according to claim 2, wherein the articulated shaft (10, 26, 27, 28) has at least two joints (10, 28; 26, 28).

6. The internal combustion engine according to claim 5, wherein an intermediate shaft (27) is arranged between each two neighboring joints (10, 28; 26, 28).

7. The internal combustion engine according to claim 1, wherein at least one of the crankshaft (1) and the connection shaft (10, 26, 27, 28) has at least one ball plunging joint.

8. The internal combustion engine according to claim 5, wherein the at least two joints have at least one of a universal joint (28), constant-velocity joint, ball joint, tripod joint, and curved-tooth gear coupling.

9. The internal combustion engine according to claim 1, wherein the crankshaft (1) is aligned in a defined pivot position with the transmission input shaft (23).

10. The internal combustion engine according to claim 9, wherein the defined pivot position corresponds to a predeterminable compression ratio.

11. The internal combustion engine according to claim 9, wherein the defined pivot position corresponds to a maximum compression ratio.

12. A drivetrain for a motor vehicle comprising:
an internal combustion engine (1) according to claim 1;
a shift transmission having an input transmission shaft (23);
wherein:
the connection shaft (10, 26, 27, 28) is arranged between the crankshaft (1) and the input transmission shaft (23).

13. The drivetrain according to claim 12, wherein the input transmission shaft (23) is supported by a bearing.
